(19) United States
(12) Patent Application Publication
(10) Pub. No.: US 2016/0086200 A1
(43) Pub. Date: Mar. 24, 2016

(54) PRODUCT CODE ANALYSIS SYSTEM AND PRODUCT CODE ANALYSIS PROGRAM

(71) Applicant: ID'S CO., LTD., Okinawa (JP)

(72) Inventors: Choken YAMAKAWA, Okinawa (JP); Kyoichi MASAKI, Okinawa (JP); Shizuko HONDA, Okinawa (JP); Kumiko KINJO, Okinawa (JP); Yo MITA, Okinawa (JP); Fumi ITO, Okinawa (JP); Minako KANAI, Okinawa (JP); Junko YAMAGUCHI, Okinawa (JP)

(73) Assignee: ID'S CO., LTD., Okinawa (JP)

(21) Appl. No.: 14/891,037

(22) PCT Filed: May 16, 2014
(86) PCT No.: PCT/JP2014/063036

§ 371 Date: Nov. 13, 2015

(30) Foreign Application Priority Data
May 17, 2013 (JP) 2013-104749

(51) Int. Cl. G06Q 30/02; G06F 17/30; G06Q 10/08

(52) U.S. Cl. CPC G06Q 30/0202; G06Q 10/087; G06F 17/30598; G06F 17/30312; G06F 17/30528

(57) ABSTRACT

A product code analysis system, which reads a classification dictionary database which links and stores keywords in each level which configures a hierarchical structure with unit columns which are where each product name is stored. It provisionally classifies and registers product names of each inputted record according to rates of appearance of the classification name keywords with respect to each record; reads a product name dictionary database which stores product name keywords associated with each unit column; and registers in the unit columns the product names of each record according to the rates of appearance of the product name keywords with respect to each provisionally registered record. When computing the rate of appearance of the keywords in the provisional classifications and the product name registrations, the product code analysis system defines the order of handling the dictionaries and keywords, and combination of keywords and the order of handling keywords.

### FIELD OF THE INVENTION

the present invention relates to a product code analysis system and a product code analysis program for analyzing an analysis target database capable of storing product names classified in a hierarchical structure as records, and collecting product names on the basis of the hierarchical structure.

### BACKGROUND ART

For retailers such as supermarkets, it is important to proceed with business development on the basis of diversified customer needs. To this end, for example, the so-called marketing research has been conducted by acquiring market data which is obtained by researching what types of products are hot sellers, and analyzing sales trend of all the products on the market.

Such a technique of analyzing sales trend is described, for example, in Patent Document 1. The technique disclosed in Patent Document 1 relates to a system for quickly and easily analyzing sales trend with reference to inventory situation in the entire market on the basis of product sales volumes acquired through POS (Point of Sales: sales time information management) terminals of retailers and warehousing quantity data of products.

### PRIOR ART LITERATURE

### Patent Document

[Patent Document 1]

Japanese Patent Published Application No. 2005-8341

### SUMMARY OF INVENTION

### Problems to be Solved by the Invention

However, while each storefront (company) independently conducts management of each product, the product information is classified into its own categories at each storefront, and managed as product master information by assigning its own product codes to products respectively. Because of this, in the case where product master information is simply collected from respective storefronts and accumulated in the form of a database, even same product can be classified into different categories so that it is impossible to accurately analyze sales trend.

Also, depending upon the storefront, the product master information may contain information about a product such as the place of production and the quantity of the product so that even the same product can be registered as different products corresponding to a product name which is associated with information about the product and a product name which is not associated with information about the product. On the other hand, while the product master information of the respective storefronts can be classified anew into categories, and product names can be renamed, there is a problem that the required process is complicated.

In order to solve the problem as described above, it is an object of the present invention to provide a product code analysis system and a product code analysis program which make it possible to classify product information which is registered at each shop in different classifications or with different product names, into a simply standardized category, and unify the product information by changing product names into appropriate product names.

### Means to Solve the Problems

In order to accomplish the object as described above, the present invention provides a product code analysis system which analyzes an analysis target database capable of storing product names classified in a hierarchical structure as records, and collects product names on the basis of the hierarchical structure, said product code analysis system comprising: an input interface through which records are input to the analysis target database while maintaining the hierarchical structure; a classification dictionary structured to store keywords of classification names in each level of the hierarchical structure together with a unit column which is the storage destination of each product name in association with each other; a product name dictionary structured to store, for each unit column classified in the hierarchical structure, keywords of product names belonging to the each unit column; a provisional classification execution unit structured to provisionally classify and register each record of the analysis target database input through the input interface in accordance with the appearance rates of the keywords of classification names in the classification dictionary; a product name registration unit structured to register, with respect to each record of the analysis target database, the product names of the each record in accordance with the appearance rates of the keywords of the product names of the product name dictionary on the basis of provisional classification and registration in the provisional classification execution unit; and a dictionary search execution unit structured to define the order of handling the dictionaries and keywords, and combination of keywords and the order of handling keywords when calculating the appearance rates of the keywords in the provisional classification execution unit and the product name registration unit.

In accordance with the present invention as described above, first, each record is provisionally classified and registered in a unit column which is the storage destination in accordance with the appearance rates of the keywords of classification names in the classification dictionary, and then the provisionally registered product name is changed to a standardized keyword and registered in accordance with the appearance rates of the keywords of product names in the product name dictionary. It is therefore possible to classify records which are registered at each shop in different classifications or with different product names, into a simply standardized unit column, and unify the product information by changing product names into appropriate product names.

Particularly, in accordance with the present invention, the dictionary search execution unit defines the order of handling the dictionaries and keywords, and combination of keywords and the order of handling keywords when calculating the appearance rates of the keywords in the provisional classification execution unit and the product name registration unit. In this case, the order of handling the keywords shows, for example, the order in which the keywords are handled by setting priority levels to the product keywords and searching for the keywords in the descending order of the priority level and searching for the keywords in the descending order of the string length. Also, the combination of keyword is combination of two or more keywords required for identifying the product name, for example, a product name, the form of the product, the maker, limited time information and so forth. Search with this combination can be performed as AND search for retrieving entries which contain all the designated keywords, OR search for retrieving entries which contain at least one of the designated keywords, and so forth. In addition to this, a plurality of keywords are concatenated, and search can be performed with the concatenated keywords as a single search keyword.

In accordance with the present invention as described above, since the order of handling the dictionaries and keywords, and combination of keywords and the order of handling keywords are defined, depending on the number of characters forming a classification or a product name and the combination of characters, even with respect to products belonging to different unit columns, the records of each storefront can be stored in an appropriate unit column by the process on the basis of an appropriate order of handling keywords or combination of keywords.

In the case of the above invention, it is preferred that an annotation dictionary is further provided which is structured to store, for each unit column classified in the hierarchical structure, information relating to product names registered in the product name dictionary; and an annotation registration unit structured to register, with respect to each record of the analysis target database, information relating to the product name of each record in the unit column, to which the product belongs, in accordance with the appearance rates of keywords in the annotation dictionary, and that the dictionary search execution unit is structured to define the order of handling the dictionaries and keywords, and combination of keywords and the order of handling keywords when calculating the appearance rates of the keywords in the annotation registration unit.

The information relating to product names as described above includes information about the place of production, the quantity, the maker, the number of contents and so forth. In this case, since information other than product names is registered in the unit column by referring to the annotation dictionary in accordance with the appearance rate of the keywords of information relating to product names, additional information other than the classification and product name of the product can be registered in association with each other.

At this time, the dictionary search execution unit defines the order of handling the dictionaries and keywords, and combination of keywords and the order of handling keywords when calculating the appearance rates of the keywords in the annotation registration unit, and thereby even in the case where the respective information belongs to different items depending on the number of characters forming information about the product and the combination of characters, the information can be stored in an appropriate item by defining the order of handling keywords or combination of keywords.

In the case of the above invention, it is preferred that the product name registration unit is structured to perform dictionary search for the product names in a provisional classification mode on the basis of the provisional classification and registration by the provisional classification execution unit, and dictionary search throughout all the classifications in a check mode irrespective of the result of the provisional classification and registration, and has a check function of notifying the search results when the results in the both modes are different from each other. In this case, while performing dictionary search for one classification in a provisional classification mode and dictionary search throughout all the classifications in a check mode, a check function is provided which notifies the search results when the results in the both modes are different from each other, and therefore, in the case where there is a product name which is shared by different classifications, the result is notified to make it possible to determine which classification is more apt for the product name.

In the case of the above invention, it is preferred that a learning function unit is further provided which is structured to reflect the dictionary search results, which are obtained in the both modes, in the corresponding dictionaries on the basis of the result of the check function. In this case, since the search results in the provisional classification mode and the check mode are reflected, it is possible to automatically classify the product in the subsequent registration process.

In the case of the above invention, it is preferred that the dictionary search execution unit is structured to decompose the product names and the related information character strings in each record into words, and each dictionary is referred to for each word after the decomposition. In this case, for example, even when a product name and product related information are collectively input to a record at a storefront, the dictionary search execution unit refers to the respective dictionaries after decomposition into words, and therefore each record can be registered in an appropriate unit column.

In the case of the above invention, it is preferred that the dictionary search execution unit is provided further with a keyword control unit structured to set the order of handling keywords on the basis of the string length of each keyword and the string length of the keyword consisting of combination of keywords. In this case, for example, in the case where a product name “AAABB” is registered while the product name dictionary contains “AAA” having a longer string length and “BB” having a shorter string length, the dictionary search execution unit can search first for “AAA” having a longer string length on the basis of the string length so as to prevent the product name “AAABB” from being registered in the classification corresponding to “BB”.

Also, when keywords related to each other, for example, AA1, AA2 and AA3 are given, the dictionary search execution unit can construct all the possible combinations of these keywords such as AA1×AA2, AA1×AA3, AA2×AA1, AA2×AA3, AA3×AA1 and AA3×AA2 to perform AND search, OR search, and so forth. In this case, more appropriate classification can be performed by searching for keywords in the descending order of the total string lengths of the keywords. Furthermore, the dictionary search execution unit may have a function of generating a new search keyword by concatenating keywords related to each other, such as AA1AA2 and AA1AA3. The order of handling keywords which are decomposed and limited can be adjusted to improve the accuracy of analysis by combining this search keyword and original keywords, arbitrarily adjusting the string length and performing AND search, OR search and so forth.

In accordance with the present invention as described above, since the order of handling keywords is determined on the basis of the string lengths of keywords or combined keywords, each record can be registered in an appropriate unit column.

The system of the present invention as described above can be implemented by running a program which are written in an appropriate language on a computer. Specifically, the present invention provides a product code analysis program which analyzes an analysis target database capable of storing product names classified in a hierarchical structure as records, and collects product names on the basis of the hierarchical structure, said product code analysis program causing a computer to perform the process comprising:

(1) an input step of inputting records to the analysis target database through an input interface while maintaining the hierarchical structure;

a provisional classification execution step of reading a classification dictionary structured to store keywords of classification names in each level of the hierarchical structure together with a unit column which is the storage destination of each product name in association with each other, and provisionally classifying and registering each record of the analysis target database input through the input interface in accordance with the appearance rates of the keywords of classification names in the classification dictionary;

(2) a product name registration step of reading a product name dictionary structured to store, for each unit column classified in the hierarchical structure, keywords of product names belonging to the each unit column, and registering, with respect to each record of the analysis target database, the product names of the each record in accordance with the appearance rates of the keywords of the product names of the product name dictionary on the basis of provisional classification and registration in the provisional classification execution step; and

(3) a dictionary search execution step of defining the order of handling the dictionaries and keywords, and combination of keywords and the order of handling keywords when calculating the appearance rates of the keywords in the provisional classification execution step and the product name registration step.

The system having the above functions, effects and advantages can be easily implemented by installing this program in a user terminal, a computer such as a Web server or an IC chip, and running this program on a CPU. This program can be distributed, for example, through a communication line, or provided as a package application which runs on a stand-alone computer.

In addition, such a program can be stored in a computer readable storage medium, so that the system and method as described above can be implemented with a general purpose computer or a dedicated computer, and the program can be easily maintained, transported and installed with the storage medium storing the program.

### Effects of the Invention

According to the present invention as has been discussed above, it is possible in each storefront to classify product information which is registered either in different classifications or product names easily into integrated categories, and to change to appropriate product names and unify the product information.

### BRIEF DESCRIPTION OF THE DRAWINGS

FIG. 1 is a schematic representation of a product code analysis system in accordance with an embodiment.

FIG. 2 shows table data containing product information in the storefront side in accordance with the present embodiment.

FIG. 3 shows table data containing various information items in a unit column accumulated on an annotation dictionary database in accordance with the present embodiment.

FIG. 4 shows table data containing various information items accumulated on an annotation dictionary database in accordance with the present embodiment.

FIG. 5 is an explanatory view for showing the general outline of a product code analysis method in accordance with the present embodiment.

FIG. 6 is a flow chart for showing a method of generating various dictionary data in accordance with the present embodiment.

FIG. 7 is a flow chart showing a method of classifying product information in accordance with the present embodiment.

FIG. 8 is a flow chart showing a method of classifying product information in accordance with the present embodiment.

### MODES FOR CARRYING OUT THE INVENTION

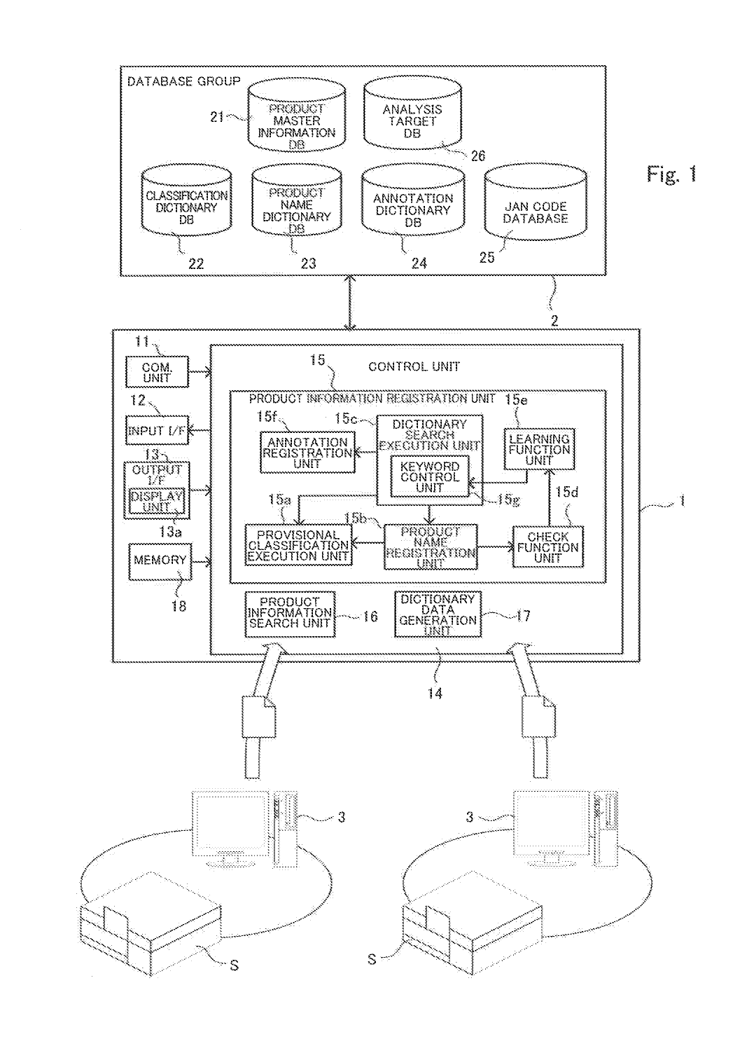

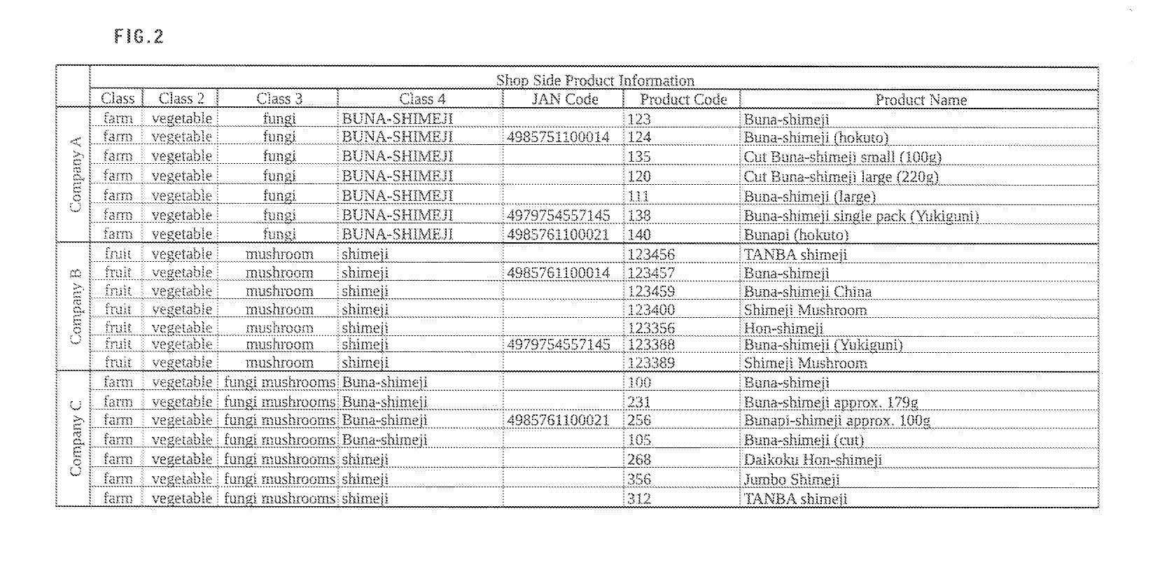

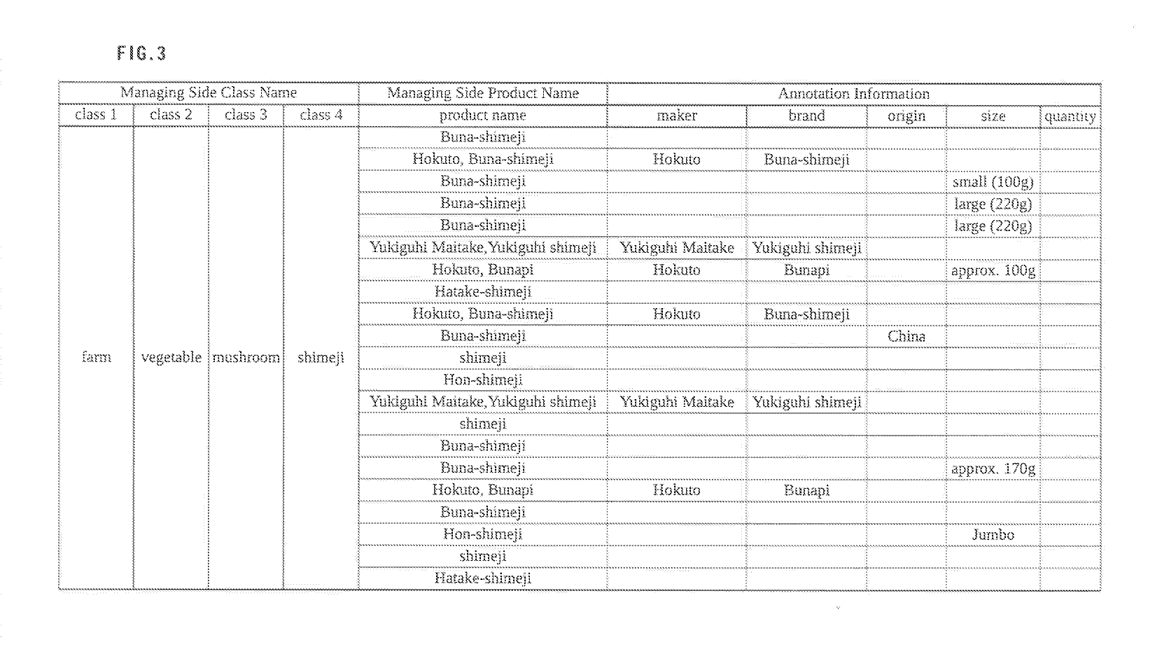

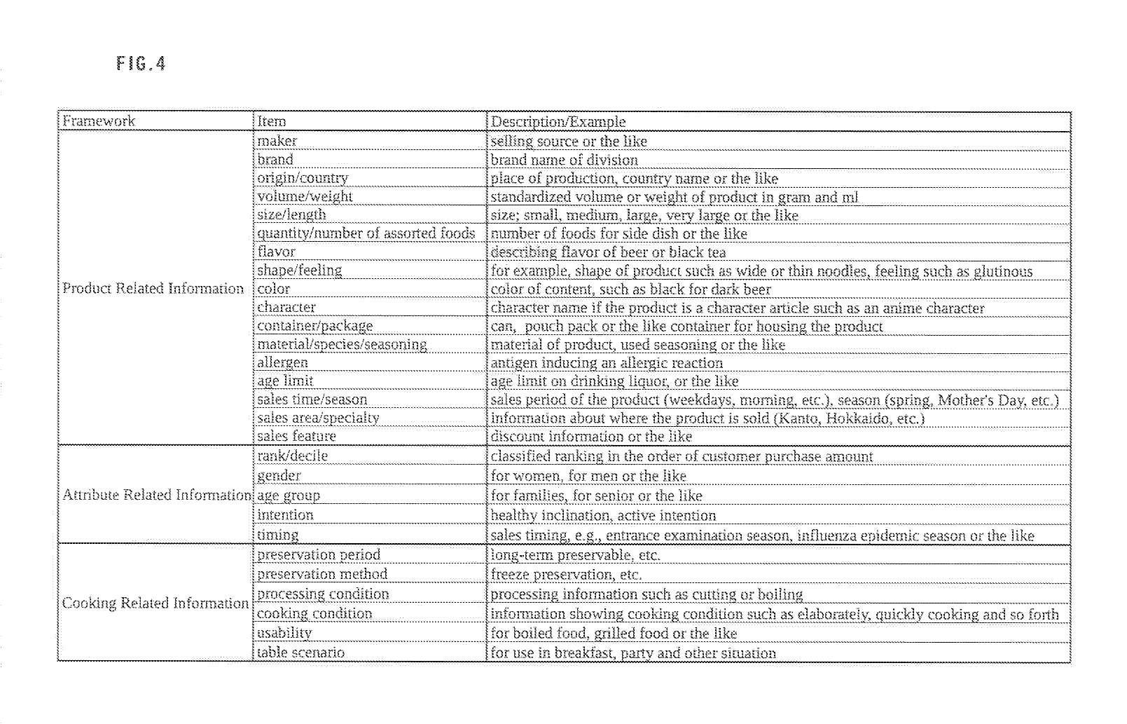

In what follows, with reference to the accompanying drawings, a product code analysis system in accordance with the present invention will be explained in detail. FIG. 1 is a block diagram showing the internal structure of a management server in accordance with the present embodiment, and FIG. 2 shows table data containing product master information accumulated on a product master information database in accordance with the present embodiment. FIG. 3 shows table data containing various information items accumulated on an annotation dictionary database in accordance with the present embodiment, and FIG. 4 shows table data containing product master information on a storefront side in accordance with the present embodiment. Meanwhile, the term “module” used in this explanation is intended to encompass any function unit capable of performing predetermined operations, as implemented with hardware such as a device or an apparatus, software capable of performing the functionality of the hardware, or any combination thereof.

The system of the present embodiment is a system consisting of a management server 1 and a database group 2 for acquiring product names generated by information processing terminals 3 or the like of a plurality of storefronts S, as records which are hierarchically classified, and processing these records on the basis of a hierarchical structure.

The information processing terminal 3 is an information processing terminal possessed by a retailer such as a supermarket selling daily necessaries and foods and equipped with a CPU providing arithmetic operational functions and a communication interface providing communication processing functions, and may be a general purpose computer such as a personal computer or a functionally specialized dedicated apparatus (for example, a POS system or the like), including a mobile computer, a PDA (Personal Digital Assistance), a cellular phone or any other similar device as a mobile terminal.

The database group 2 serves as a database server which accumulates information about the present system, and also accumulates records of respective storefronts, which are integrally stored as product information, and dictionary data which is used when the record information is separately registered for each storefront.

Specifically describing, this database group 2 includes a product master information database 21, a classification dictionary database 22, a product name dictionary database 23, an annotation dictionary database 24, a JAN code database 25 and an analysis target database 26.

The analysis target database 26 contains table data in which is stored product information including product names used by each storefront as an analysis target in order to store product names hierarchically classified in units of records. Specifically, the analysis target database 26 stores product information in fields of “classification 1 through classification 4”, “JAN code”, “product code” and “product name” separately as illustrated in FIG. 2. In this case, “classification 1 through classification 4” indicates attribute information about products relating to respective divisions. In the case shown in FIG. 2, classification 1 shows agricultural division, classification 2 shows commodity group such as vegetable, classification 3 shows more specific commodity group such as fungi, and classification 4 shows species such as shimeji.

“JAN code” stores the common commodity codes of Japan, and “product code” stores codes which are independently assigned by storefronts. Also, “product name” stores information showing product names and including information about products indicative of content such as the place of production and the quantity of the product.

The product master information database 21 is implemented with a storage device for storing the product name of each record, which is input, in a unit column which is the storage destination of the product name. In this case, the unit column is used to store information specified by “classification 1 through classification 4”, and the example shown in FIG. 3 is the unit column relating to “shimeji”. Furthermore, in this unit column, the “product name” of each product and “annotation information” as product related information are stored in the database.

The fields of “classification 1 through classification 4” is used to store attribute information about products relating to respective divisions. In the case shown in FIG. 3, classification 1 shows agricultural division, classification 2 shows commodity group such as vegetable, classification 3 shows more specific commodity group such as fungi, and classification 4 shows species such as shimeji.

Also, the field of “product name” is used to store the names of products to which are added predetermined annotation information about products indicative of content such as the place of production and the quantity of the product. Furthermore, the field of “annotation information” is used to store descriptive information which explains the product, and the example shown in FIG. 3 stores “maker” which indicates information of the manufacturer, “brand” which can distinguish the product from others, “origin” which identifies the place of production, “size” which shows the dimension and weight of the product, “quantity” which indicates the selling configuration such as the number of contents in a case, and so forth. Incidentally, while annotation information is added to product names in the case of the present embodiment, only product names may be stored alone.

Meanwhile, although not shown in the figure, the product master information database 21 includes management side identification information for identifying each product. Also, the other databases store identification information for identifying storefronts, and use information including sales situation of each product in association with the management side identification information. The use information here includes sales situation information such as “average price”, “sales amount”, “sales volume”, “selling storefront ratio”, “national sales final results”, and update situation information such as “update time”. It is therefore possible to analyze information about each product by searching use information of the product and searching product information separately for each storefront. In this case, if annotation information is added to the field of “product name”, search can be performed with combination of a product name and annotation information.

The classification dictionary database 22 is a storage device which stores keywords of classification names in each level of a hierarchical structure together with a unit column which is the storage destination of each product in association with each other. In the case of the present embodiment, of the keywords appearing from each classification, keywords having high appearance rates are stored as keywords for classification, and keywords having low appearance rates are accumulated in association with the keywords having high appearance rates.

The product name dictionary database 23 is a storage device which stores, for each unit column classified in a hierarchical structure, keywords of product names belonging to each unit column. In the case of the present embodiment, of the keywords of product names appearing from each classification, a keyword having the highest appearance rate is stored as a keyword for assigning product names, and keywords having low appearance rates are accumulated in association with the keyword having the highest appearance rate.

The annotation dictionary database 24 is a storage device which stores, for each unit column classified in the hierarchical structure, information (information other than product names) relating to product names registered in the product name dictionary database 23. Words accumulated in this annotation dictionary database 24 are generally devided, as shown in FIG. 4, into “product related information”, “attribute related information” and “cooking related information”, and further classified in accordance with the content. Specifically, “product related information” is used to store information related to product, and classified into “maker”, “brand”, “origin/country”, “volume/weight (kg, ml)”, “size/length”, “quantity/number of assorted foods”, “flavor” indicative of the kind of taste, “character” indicative of character name, “container/package” indicative of the type of container such as can or pouch pack, “material/species/seasoning”, “allergen” indicative of antigen inducing an allergy, “age limit” indicative of purchase age limit, “sales time/season” indicative of the sales period of product (weekdays, morning, during the Olympic Games and/or the like) and season (spring, Mother's Day and/or the like), “sales area/specialty” indicative of selling areas and the like information, “sales feature” indicative of discount information or the like, and/or the like item.

Furthermore, “attribute related information” is used to store information about the target of selling products, and classified into “rank/decile” showing classification in the order of purchase amount, “gender”, “age group”, “intention” indicative of intention information of customers, “timing” indicative of selling times, and/or the like item. Still further, “cooking related information” is used to store information about cooking products, and classified into “preservation period”, “preservation method”, “processing condition”, “usability”, “table senario” indicative of the senario where a product is used, and/or the like item. Incidentally, each data described above is stored in the annotation dictionary database 24 even in the case where a storefront has some of the above items.

The JAN code database 25 is used to store JAN codes, which are common commodity codes, with which are associated with words contained in classifications 1 through 4, product names and annotation information. Incidentally, the JAN code database 25 includes definitive JAN table data in which classifications, product names and the like common to all the storefronts are associated with JAN codes, and temporary JAN table data in which the management side temporarily assigns provisional classifications and provisional product names to JAN codes. This is because it is difficult to accumulate all the new products having JAN codes, which are daily registered and updated, in the definitive JAN table data, so that the management side first accumulates classifications and product names given by the management side in association with JAN codes as temporary JAN table data. The information accumulated in the temporary JAN table data is processed at predetermined intervals in order to obtain consistency with the definitive JAN table data so that it is possible to switch the provisionally registered classifications and product names to definitive classifications and product names. The registration in the temporary JAN table data may be performed as user operation conducted at the management side, or alternatively, product information which is not registered in the definitive JAN table may be automatically registered.

On the other hand, the management server 1 is a server unit which classifies product information obtained from storefronts for each unit column and registers the product information in the database, and implemented with a server computer capable of performing a variety of information processing or software capable of performing the functionality of the server computer. This management server 1 is provided with a communication interface 11, an input interface 12, an output interface 13, and a control unit 14 as illustrated in FIG. 1.

The input interface 12 is a device such as a mouse and a keyboard for inputting user manipulation. In the case of the present embodiment, records are input to the analysis target database 26 while the hierarchical structure is maintained. The output interface 13 is a device such as a display or a speaker for outputting images and sound. Particularly, this output interface 13 includes a display unit 13a such as a liquid crystal display. The communication interface 11 is a communication interface through which telephone conversation and data communication can be performed, and capable of transmitting and receiving packet data through a communication network to acquire records of each storefront. A memory 18 is a storage device which stores an OS, a product code analysis program according to the present embodiment, and so forth.

The control unit 14 is an arithmetic operation module composed of hardware elements, for example, processor(s) such as a CPU and a DSP (Digital Signal Processor), a memory, and other necessary electronic circuits, and software (and/or firmware) for implementing necessary functions in combination with the hardware. Several function modules can be virtually implemented by the software for performing the processes of controlling the operations of the respective units, and performing a variety of processes in response to the manipulation by the user. In the case of the present embodiment, the control unit 14 is provided with a product information registration unit 15, a product information search unit 16 and a dictionary data generation unit 17.

The dictionary data generation unit 17 is a module for constructing a variety of dictionary databases. The dictionary data generation unit 17 first receives information such as product names as samples, and extracts words from the respective items of the product information by a language analysis program such as a morpheme analysis process.

The dictionary data generation unit 17 then calculates the appearance rates of keywords for each items, sets a keyword having the highest appearance rate to a standardized word, and accumulates the standardized word in the dictionary databases. In what follows, the settings of this dictionary data will be described in detail. Meanwhile, as illustrated in FIG. 2 in the case of the present embodiment, it is assumed that records of company A, company B and company C are input as data for dictionary registration.

First, a dictionary database is built with the keywords of classifications 1 through 4 on the basis of product information input from the storefronts. In the case of the present embodiment, classification 1 takes on “farm” for company A, “fruit” for company B and “farm” for company C. The dictionary data generation unit 17 here sets “farm” which has the highest appearance rate as a keyword having the highest appearance rate for classification 1.

Also, classification 2 takes on “vegetable” commonly for company A, company B and company C, and therefore “vegetable” which has the highest appearance rate is set as a keyword having the highest appearance rate. Furthermore, classification 3 takes on “fungi” for company A, “mushroom” for company B and “fungi mushrooms” for company C. In this case, “mushroom” of company B which has the highest appearance rate is set as a keyword having the highest appearance rate for classification 3.

Still further, classification 4 takes on “BUNA-SHIMEJI” for company A, “shimeji” for company B and “Buna-shimeji” and “shimeji” for company C. In this case, “shimeji” of company B and company C which has the highest appearance rate is set as a keyword having the highest appearance rate for classification 4. Meanwhile, keywords which are not set as the keyword having the highest appearance rate, i.e., which have low appearance rates, are associated with the keyword having the highest appearance rate and stored in the dictionary databases.

Next is description of building keywords of product names in the dictionary databases. First, the dictionary data generation unit 17 accepts the process of replacing the product names, which are contained in the product master information, by bare product names. For example, in the case where the product name is “Buna-shimeji (hokuto)” as illustrated in FIG. 4, the strings “(hokuto)” is removed to substitute the word “Buna-shimeji” alone. The dictionary data generation unit 17 then collects, of the product names, words having the same pronunciation and registers the product name having the highest appearance rate as a keyword having the highest appearance rate. In this case, while “BUNA-SHIMEJI” and “Buna-shimeji” have the same pronunciation, the word “Buna-shimeji” has the highest appearance rate and therefore the product name is set to “Buna-shimeji”. At this time, the keywords registered in a division may be accompanied by priority levels which indicate the order of handling the keywords during operation.

In this case, the dictionary data generation unit 17 accepts the process of combining two or more keywords required for identifying the product, for example, a product name and the form of the product, and registering the combination as keywords. Furthermore, even in the case where, depending upon the area, the same product is called differently (for example, “shungiku” in the Kanto region is “kikuna” in the Kansai region), selection operation is accepted as to which product name is set as a keyword in order to standardize the product name.

Next is description of setting annotation information in the annotation dictionary database. The dictionary data generation unit 17 stores information relating to products as the respective items of the annotation dictionary database 24. For example, as illustrated in FIG. 3, “hokuto” extracted from “Buna-shimeji (hokuto)” which is a product name of company A is registered as an item in the “maker” field in response to user operation. Then, also with respect to annotation information, the appearance rates of keywords are calculated for each item, and the keyword having the highest appearance rate is set and accumulated in the dictionary databases.

By the process of the dictionary data generation unit 17 as described above, the keywords of the classifications, product names and annotation information can be built in the respective databases. The product information registration unit 15 then analyzes the product information (the product names, the classification names of each storefront, the annotation information and so forth) input from each storefront with reference to the dictionary databases 22 to 25 which are thus constructed, and collects the analyzed information as standardized information in the product master information database 21.

The product information registration unit 15 is provided with a provisional classification execution unit 15a, a product name registration unit 15b, a dictionary search execution unit 15c, a check function unit 15d, a learning function unit 15e and an annotation registration unit 15f.

The provisional classification execution unit 15a is a module for provisionally classifying and registering, with respect to the records of the analysis target database 26 input through the input interface 12, the product names of the respective records in the classification dictionary database 22 in accordance with the appearance rates of the keywords of the classification names. More specifically, when a record is input, the provisional classification execution unit 15a compares the classification name of the record with the keywords of the classification names of the classification dictionary database 22 from classification 1 to the classification 4 in this order, replaces the classification name of the record by the keyword having the highest appearance rate, and provisionally classifies and registers the classification name.

For example, it is assumed that the records of company A are input as illustrated in FIG. 2. Then, of the records as input, the word “farm” of classification 1 and the word “vegetable” of classification 2 are the same as the keywords having the highest appearance rates stored in the classification dictionary database 22, and therefore provisionally classified and registered in classification 1 corresponding to “farm” and classification 2 corresponding to “vegetable” respectively. On the other hand, referring to the classification dictionary database 22, with respect to the word “fungi” of classification 3, since there is the keyword “mushroom” having a higher appearance rate than “fungi”, which is thereby associated with “mushroom”, this record is provisionally classified and registered in classification 3 corresponding to “mushroom”. Also, the word “BUNA-SHIMEJI” of classification 4 is provisionally classified and registered in classification 4 corresponding to “shimeji” which is the keyword having a higher appearance rate.

Likewise, when the records of company B are input, since there is the keyword “farm” having a higher appearance rate than “vegetable” in the classification dictionary database 22, “vegetable” is provisionally classified and registered in classification 1 corresponding to “farm”. The keywords subsequently input, i.e., “vegetable” of classification 2, “mushroom” of classification 3 and “shimeji” of classification 4 are the keywords having higher appearance rates, and thereby provisionally classified and registered corresponding to the keywords.

Also, when the records of company C are input, the word “farm” of classification 1 and the word “vegetable” of classification 2 are the same as the keywords having the highest appearance rates stored in the classification dictionary database 22, and therefore provisionally classified and registered in classification 1 corresponding to “farm” and classification 2 corresponding to “vegetable” respectively. On the other hand, referring to the classification dictionary database 22 with respect to the word “fungi mushrooms” of classification 3, since there is the keyword “mushroom” having a higher appearance rate than “fungi mushrooms”, and thereby this record is provisionally classified and registered in classification 3 corresponding to “mushroom”. Also, the word “Buna-shimeji” of classification 4 is provisionally classified and registered in classification 4 corresponding to “shimeji” which is the keyword having a higher appearance rate. Incidentally, the words which are not accumulated in the dictionary databases are input to the dictionary data generation unit 17 for dictionary registration.

The product name registration unit 15b is a module for registering, with respect to the respective records of the analysis target database 26, the product names of the records in accordance with the appearance rates of the keywords of the product names of the product name dictionary database 23 on the basis of provisional classification and registration in the provisional classification execution unit 15a.

The process of this product name registration unit 15b will be described in detail. First, the product name registration unit 15b successively compares the product names of records, which are input, with the keywords of each division stored in the product name dictionary database 23, detects the keyword associated with the input product name and having the highest appearance rate, and registers the keyword having the highest appearance rate in the item “product name” of the unit column.

More specifically, when the records of company A is input as illustrated in FIG. 2, “Buna-shimeji” on the first line is the same as “Buna-shimeji” which is the keywords having the highest appearance rate, and therefore registered in the unit column.

On the other hand, referring to the product name dictionary database 23, with respect to “Tanba-shimeji” which is a product name of company B, “Hatake-shimeji” is set to the keyword having the highest appearance rate. Accordingly, the product name of company B, “Tanba-shimeji”, is converted into “Hatake-shimeji” which is then registered in the unit column. Also, “Shimeji Mushroom” of company B is converted into “shimeji” which is then registered. The other records are converted into the keywords having the highest appearance rates and registered.

The annotation registration unit 15f is a module for registering the annotation information of the product with reference to the annotation dictionary database 24. More specifically, the annotation registration unit 15f registers, with respect to the respective records of the analysis target database 26, information relating to the product name of each record in the unit column, to which the product belongs, in accordance with the appearance rates of the keywords in the annotation dictionary database 24.

For example, if the keyword which is selected is “hokuto” as illustrated in FIG. 2, it is determined whether or not this word is contained in the annotation dictionary database 24. In this case, since the word “hokuto” is a word which is registered as an item of “maker”, the annotation registration unit 15f sorts the word “hokuto” into the item of “maker” as illustrated in FIG. 3. Likewise, the keyword having the highest appearance rate for each item is sorted into the corresponding item of the annotation information. For example, the keyword “China” is sorted into the item “origin”, and a keyword consisting of a numeral plus g (gram) is sorted into the item “size”.

The dictionary search execution unit 15c is a module for defining the order of handling the dictionaries and keywords, and combination of keywords and the order of handling keywords when calculating the appearance rates of the keywords in the provisional classification execution unit 15a and the product name registration unit 15b.

In this case, the order of handling the dictionaries and keywords may be determined, for example, by setting priority levels to the product keywords and searching for the keywords in the descending order of the priority level and searching for the keywords in the descending order of the string length. Meanwhile, the search based on the string length is performed with a keyword control unit 15g. This keyword control unit 15g is a module for setting the order of handling keywords on the basis of the string length of each keyword and the string length of the keyword consisting of combined keywords.

In the case of the present embodiment, there are ten levels of priority assigned to the product keywords in all the divisions so that search is performed for keywords in the descending order of the priority level while, with respect to keywords having the same priority level, search for keywords is performed in the descending order of the string length.

For example, in the case where a product name “AAABB” is registered while a long keyword “AAA” and a short keyword “BB” have the same priority in the product name dictionary, the dictionary search execution unit can search the dictionary firstly for the long keyword “AAA” on the basis of the string length to prevent the product name “AAABB” from being registered in the classification corresponding to “BB”. On the other hand, in the case where the short keyword “BB” has a higher priority level than the long keyword “AAA”, the same product name “AAABB” is registered in the product column corresponding to “BB”. Incidentally, the order of handling keywords can be arbitrarily selected in accordance with the divisions and the product names, and it is possible to perform search on the basis of either one of the priority and the string length. Alternatively, the application of the search orders can be interchanged such that search is performed firstly by referring to the string length, and then by referring to the priority if keywords have the same string length. Furthermore, the number of priority levels can be arbitrarily changed.

The dictionary search execution unit 15c is provided also with a function of determining combination of keywords. Specifically, the dictionary search execution unit 15c can perform search by combining two or more keywords required for identifying a product name. The information associated with a product is information contained in the annotation dictionary database 24, for example, “the form of product”, “maker”, “sales time/season”, “flavor”, and the like which can be arbitrarily extracted from the database. The extraction method may be performed, for example, by showing a screen to prompt an operator to select which search condition is used to perform search and accepting the selected search condition, or by searching predetermined combinations of keywords in a preset order.

When keywords related to each other, for example, AA1, AA2 and AA3 are given, the dictionary search execution unit 15c can construct all the possible combinations of these keywords such as AA1×AA2, AA1×AA3, AA2×AA1, AA2×AA3, AA3×AA1 and AA3×AA2 to perform, for example, AND search for retrieving entries which contain all the designated keywords, OR search for retrieving entries which contain at least one of the designated keywords, and so forth. In this case, more appropriate classification can be performed by searching for keywords in the descending order of the total string lengths or in accordance with the priority levels of the keywords. Furthermore, the dictionary search execution unit 15c may have a function of generating a new search keyword by concatenating keywords related to each other, such as AA1AA2 and AA1AA3. The order of handling keywords which are decomposed and limited can be adjusted to improve the accuracy of analysis by combining this search keyword and original keywords, arbitrarily adjusting the string length and performing AND search, OR search and so forth. Also, even if another word is interposed between combined keywords, the interposed word is not considered for the purpose of determination so that determination is possible even with such a word interposed between combined keywords.

Incidentally, for the purpose of inputting the product names and the related information in records to the provisional classification execution unit 15a and the product name registration unit 15b, the dictionary search execution unit 15c decomposes the product names and the related information character strings in each record into words by a language analysis program such as a morpheme analysis process, and refers to the dictionaries with each word generated by decomposition. For example, as illustrated in FIG. 2, “Buna-shimeji (hokuto)” which is a product name input from company A is decomposed into “Buna-shimeji” and “hokuto”.

In addition, the dictionary search execution unit 15c is provided with a function of defining the order of handling the dictionaries and keywords, and combination of keywords and the order of handling keywords also when calculating the appearance rates of the keywords in the annotation registration unit 15f.

Meanwhile, the dictionary search execution unit 15c is provided with a function of, in the case where the records acquired from storefronts include JAN codes as illustrated in FIG. 2, extracting the words contained in annotation information, the product names and the classifications 1 through 4 which are associated with JAN codes with reference to the JAN code database 25, and registering them in the product master information database 21 as illustrated in FIGS. 3 (P1 to P5 in the figure). In this case, the product names are registered, for example, by combining annotation information such as maker names, brand names and so forth.

The check function unit 15d is a module for performing dictionary search for product names in a provisional classification mode on the basis of the provisional classification and registration by the provisional classification execution unit 15a, performing dictionary search over all the classifications in a check mode irrespective of the result of the provisional classification and registration, and notifying the search results when the results in the both modes are different from each other. The notification of the check function includes notification by means of email or the like, and notification by popping up the results in the both modes on the display unit 13a. Also, the dictionary search execution unit 15c is provided with a function of accepting the selection of the classification (division) for registration after notification.

Furthermore, in the case where a JAN code contained in the product information which is input is not registered in the JAN code database 25, the check function unit 15d determines whether or not the JAN code is contained in the temporary JAN table data by referring to the temporary JAN table data. If the JAN code is not contained even in the temporary JAN table data, this information is notified on the display unit 13a followed by accepting user operation as to which classification (division) is used for registration.

On the other hand, if the JAN code is contained in the temporary JAN table data, the product information is classified in the provisional classification corresponding to the JAN code in the temporary JAN table data. Even in this case, it is possible to accept the operation of changing the destination classification by displaying the classification result on the display unit 13a. Furthermore, the check function unit 15d also has a function of moving a particular product name to another destination classification on the basis of user's intention. Incidentally, this user operation can be accepted, for example, by displaying a list of unit columns on a screen on which the operator can move the particular product name to an arbitrary unit column by performing intuitive operations such as drag and drop.

The learning function unit 15e is a module for reflecting, in the corresponding dictionary, the dictionary search results obtained in the both modes on the basis of the result of the check function. Specifically, through the keyword control unit 15g on the basis of user operation accepted by the check function unit 15d, the learning function unit 15e modifies dictionary data, changes the order of handling keywords, automatically accumulating the product in the unit column corresponding thereto without notification when the same product is input again. Also, when performing a modification operation to move a particular product name which has been classified in a unit column to an arbitrary destination classification, the learning function unit 15e automatically change the order of handling keywords or the like when the same product is input in order to reflect the modification operation in the dictionary search results.

The process of this learning function unit 15e will be described in detail. For example, in the case where a particular product name is moved to an arbitrary destination classification on the basis of user's intention or as a result of the check function, the product name to be moved and the unit column as a destination are specified by drag and drop or the like on a list of unit columns (classifications) displayed on a screen. The learning function unit 15e changes the order of handling keywords, in response to the modification operation, by automatically changing the priority levels assigned to keywords, the string length and combination with other keywords for the purpose of preventing the modification operation from influencing on the search result of another keyword.

Specifically, the modification operation is performed by the following process.

(1) At first, the current classification and the destination classification after moving are compared to determine which classification is subjected to search operation prior to the other classification, and determine whether the turn of handling the product name (keyword) to be moved is shifted earlier or later (moving type determination process).
(2) Next, on the basis of the determination result of the moving type determination process, the range in which the modification operation may influence is determined (range determination process). Specifically, depending upon whether the turn of handling the product name to be moved is shifted earlier or later, it is determined whether to perform examination within the range of keywords having higher priority levels or longer string lengths than the product name to be moved or to perform examination within the range of keywords having lower priority levels or shorter string lengths than the product name to be moved.
(3) It is then determined whether or not there is influence on the keywords within the range determined by the range determination process. Specifically, keywords associated with the current classification to which the product name to be moved belongs and the destination classification after moving are extracted by performing a reverse look-up process which refers to dictionaries including, as search results, the current classification and the destination classification after moving (reverse look-up extraction process).

Next, by comparing the keywords extracted by the reverse look-up extraction process and the product name (keyword) to be moved, the priority levels are adjusted, and search keywords are generated in accordance with the priority levels and the string length of these keywords. Since there is a restriction on priority levels in the case of the present embodiment, the above influence is removed, as possible, by generating search keywords. Only when the influence cannot be removed by generating search keywords, the priority levels are adjusted. The generation of a search keyword can be performed, for example, by concatenating keywords related to each other, such as AA1AA2 and AA1AA3, to generate a new search keyword and combining this search keyword and original keywords to arbitrarily adjust the string length. The dictionary search execution unit 15c performs an AND search for a plurality of keywords, and handles the plurality of keywords in the descending order of the string length, and therefore the order of handling keywords can be adjusted by generating a search keyword having an appropriate string length.

The product information search unit 16 is a module for searching the product information of each master data in accordance with search conditions with reference to the product master information database 21. Incidentally, the search conditions can be set up with respect to the classifications 1 through 4, product names and annotation information and independently for each storefront on the basis of storefront identification information. Also, with respect to the product which is retrieved, the sales situation thereof can be retrieved on the basis of the storefront identification information.

(Product Code Analysis Method)

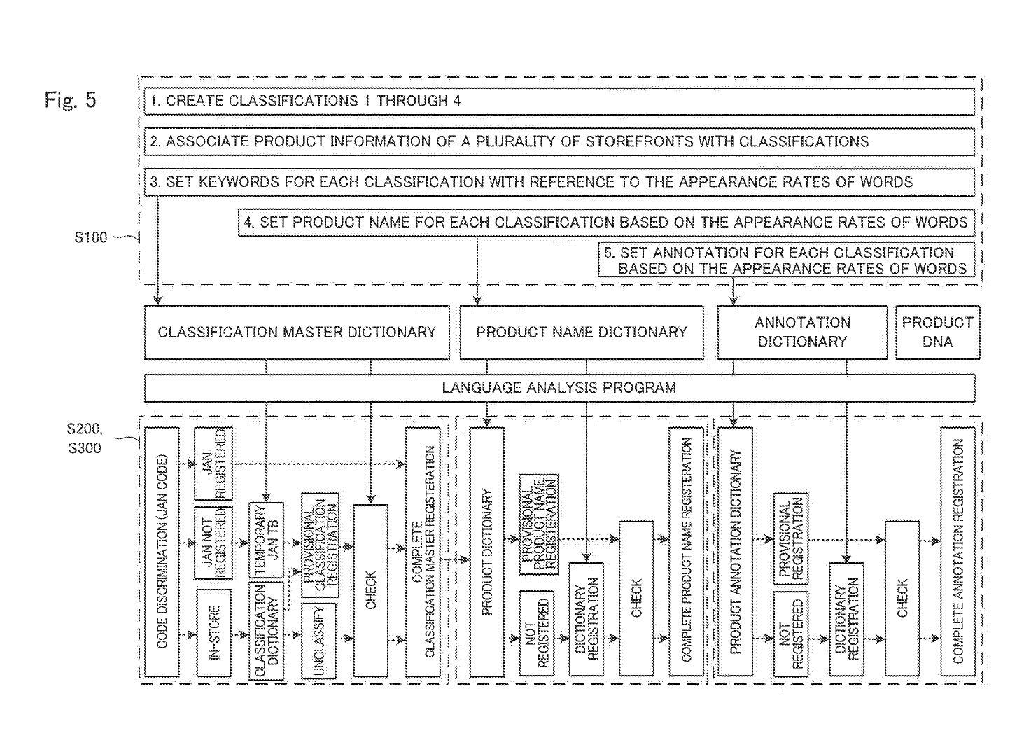

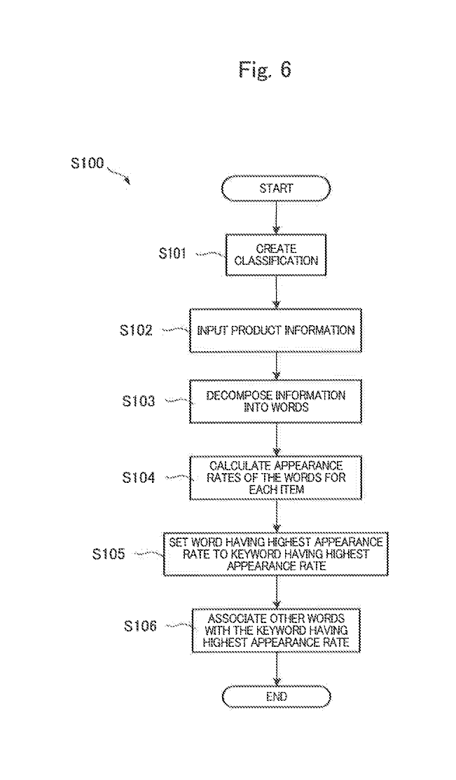

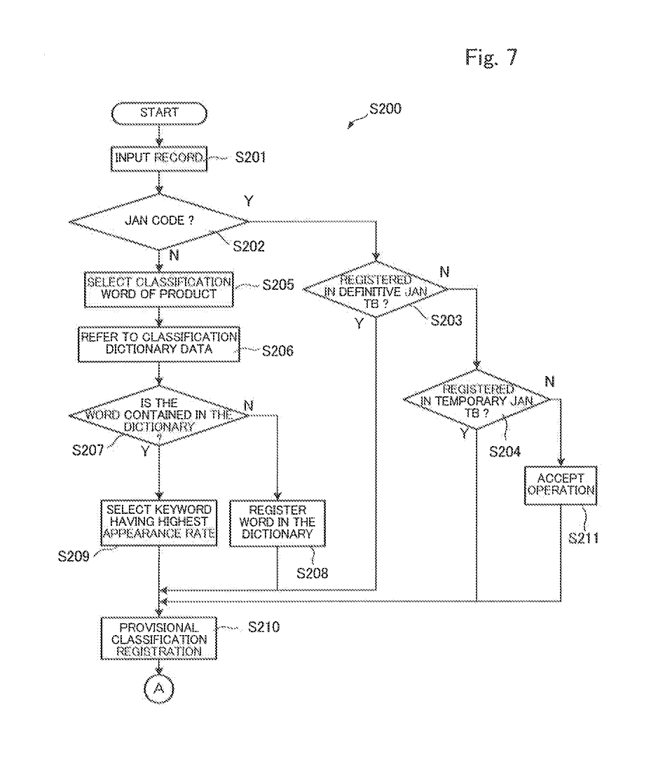

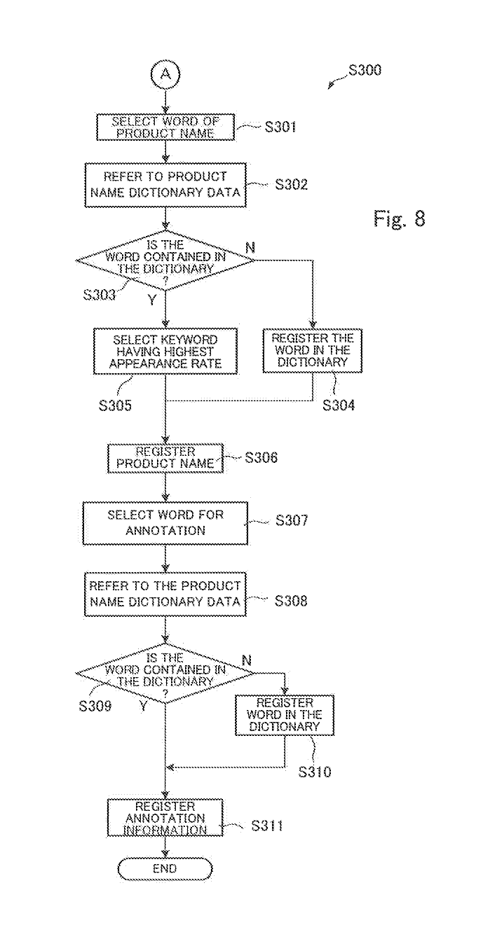

A product code analysis method can be performed by operating the product code analysis system having the structure as described above to collect records in a standardized database. FIG. 5 is an explanatory view for showing the general outline of a product code analysis method in accordance with the present embodiment; FIG. 6 is a flow chart for showing a method of generating various dictionary data in accordance with the present embodiment; and FIG. 7 and FIG. 8 show a flow chart showing a method of classifying product master information in accordance with the present embodiment.

As illustrated in FIG. 5, first, various dictionaries for analysis are constructed (generated) in step S100, and then records input from each storefront are classified and registered in the standardized product master information database in steps S200 and S300.

(1) Method of Generating Various Dictionary Data

A method of generating dictionary data will be explained. First, as illustrated in FIG. 6, the number of classifications as the categories of products is determined (S101). In the case of the present embodiment, the products are divided into classification 1 (covered division), classification 2 (commodity group), classification 3 (more specific commodity group), classification 4 (species).

Next, the dictionary data generation unit 17 accepts records which are input as samples (S102). This input record may be information which is input through a selectable product list displayed on a browser, or information which is read from data stored in a recording medium.

When the acceptance of inputting records is completed, the dictionary data generation unit 17 extracts words from the respective items of classifications 1 through 4, product name and annotation information (S103). The appearance rates of keywords for each item are calculated followed by setting a keyword having the highest appearance rate and accumulating the set keyword in the dictionary databases (S105). The keyword having low appearance rates are associated with the keyword having the highest appearance rate, and stored in the dictionary databases (S106).

(2) Method of Classifying Product Names

Next, the method of classifying product names of records will be explained. Meanwhile, in the case of the present embodiment, the order of handling the dictionaries and keywords, and combination of keywords and the order of handling keywords are defined in advance. This handling definition includes setting the order of handling keywords on the basis of the string length of each keyword and the string length of the keyword consisting of combination of keywords. In the case of the present embodiment, it is assumed that search is performed for keywords in the descending order of the priority level while, with respect to keywords having the same priority level, search is performed for keywords in the descending order of the string length. Furthermore, also with respect to annotation information, it is assumed that the order of handling keywords, and combination of keywords and the order of handling keywords are set up.

First, as illustrated in FIG. 7, each record of the analysis target database 26 is input through the input interface 12 (S201) while maintaining its hierarchical structure, and then the dictionary search execution unit 15c determines whether or not a JAN code is contained in the record (S202). If a JAN code is contained in the record (“Y” in S202), it is determined whether or not the JAN code is registered in the definitive JAN table data of the JAN code database 25 (S203). If the JAN code is registered in the definitive JAN table data (“Y” in S203), the classification of the product (classifications 1 through 4), product names and annotation information are determined and registered on the basis of the JAN code.

On the other hand, if the JAN code is not registered in the definitive JAN table data (“N” in S203), it is determined whether or not the JAN code is contained in the temporary JAN table data with reference to the temporary JAN table data (S204).

If the JAN code is contained in the temporary JAN table data (“Y” in S204), the record is provisionally classified and registered by selecting the provisional classification and the provisional product name assigned to the JAN code (S210). At this time, the provisional classification result is displayed on the display unit 13a, followed by accepting the operation of changing the destination classification.

On the other hand, if the JAN code is not registered in the temporary JAN table data (“N” in S204), the dictionary search execution unit 15c extracts words from each information registered in the record for each item, and the product names and the related information character strings in each record are decomposed into words by morpheme analysis. Then, information notification is displayed on the display unit 13a by the check function unit 15d to accept user operation (S211). Thereafter, in accordance with user operation, the check function unit 15d registers the selected keyword of the classification in the respective dictionaries and provisionally classifies and registers the product information in the classification (S210).

If a JAN code is not contained in the record (“N” in S202), with respect to each record of the analysis target database 26 input through the input interface 12, the provisional classification execution unit 15a provisionally classifies and registers the product name of each record in accordance with the appearance rates of the keywords of the classification names in the classification dictionary database 22. Specifically, this process is performed by reading the keywords of the classification names in each division (S205), referring to the classification dictionary database 22, and determining whether or not the classification name of the record is registered in the classification dictionary database 22 (S207).

If the classification name of the record is registered in the classification dictionary database 22 (“Y” in S207), in accordance with the appearance rates of the keywords (S209), the record is provisionally classified and registered in the unit column corresponding to the highest appearance rate (S210). On the other hand, if the classification name of the record is not registered in the classification dictionary database 22 (“Y” in S207), the keyword corresponding to the classification is registered anew in the dictionaries (S208). Specifically, the dictionary search execution unit 15c extracts words from each information registered in the record for each item, and the product names and the related information character strings in each record are decomposed into words by morpheme analysis. Then, information notification is displayed on the display unit 13a by the check function unit 15d to accept user operation. In accordance with user operation, thereafter, the check function unit 15d registers the keyword of the classification in the respective dictionaries and provisionally classifies and registers the product information in the classification (S210).

Next, with respect to each record of the analysis target database 26 as illustrated in FIG. 8, the product name registration unit 15b performs a product name registration step of registering the product name of each record in a unit column in accordance with the appearance rates of the keywords of the product names in the product name dictionary database 23.

Specifically, this process is performed by selecting a record which is provisionally classified and registered in the provisional classification registration step (S301), reading the product name dictionary database 23 for each unit column classified in the hierarchical structure (S302), and determining whether or not the product name is registered in the product name dictionary database 23 (S303).

If the selected product name is not registered in the product name dictionary database 23 (“N” in S303), the word of the product name is registered in the dictionaries (S304), followed by registering the product name in a unit column (S306). Meanwhile, the word registration process in the dictionary is performed in the same manner as in step S103 through step S106. On the other hand, if the product name is registered in the product name dictionary database 23 (“Y” in S303), in accordance with the appearance rates of the keywords of the product name (S305), the product name is registered in the corresponding unit column (S306).

Meanwhile, this product name registration step is performed by a provisional classification mode to search the dictionary for a product name on the basis of provisional classification and registration in the provisional classification registration step, and a check mode to search dictionaries throughout all the classifications irrespective of the result of the provisional classification and registration, and notifying the search results when the results in the both modes are different from each other. In this case, the results in the both modes are reflected in the corresponding dictionaries on the basis of the result of the check step.

Next, with respect to each record of the analysis target database 26, the annotation registration unit 15f performs an annotation registration step of registering information relating to the product name of each record in the unit column, to which the product belongs, in accordance with the appearance rates of the keywords in the annotation dictionary database 24.

Specifically, first, this process is performed by reading information relating to product names registered in the product name dictionary database 23, and the annotation dictionary database 24 which stores information for each unit column (S307 and S308), and determining whether or not the word is registered in the dictionary (S309).

If the selected word is registered in the annotation dictionary database 24 (“Y” in S309), annotation information is registered with the items for example, “maker”, “brand”, “origin”, “size” and “the number of contents”) corresponding to the word which is registered (S311). On the other hand, if the selected word is not registered in the annotation dictionary database 24 (“N” in S309), that annotation information is registered in the dictionary (S310) and registered in each item (S311). Incidentally, the word registration process in the dictionary is performed in the same manner as in step S103 through step S106. Furthermore, the annotation registration unit 15f repeats the process in steps S307 to S311 until all the words in a record has been handled.

Thereafter, the subsequent record is referred to, and the process in steps S201 to S311 is repeated in the same manner until all the records has been handled.

(Product Code Analysis Program)

The product code analysis system and the product code analysis method as described above can be implemented by running a product code analysis program which are written in an appropriate language on a computer. Namely, the system having the respective features as described above can be easily constructed by installing this program on a mobile terminal consisting of a personal digital assistant (PDA) in which cellular phone capability and communication capability are implemented, a personal computer used in the client side, a server unit arranged on a network to provide data and functions in the client side, a dedicated apparatus such as a game apparatus, or an IC chip, and running this program on a CPU. This program can be distributed, for example, through a communication line, or provided as a package application which runs on a stand-alone computer.

Then, this type of program can be stored in a computer readable storage medium. Specifically, the program can be stored in a variety of storage medium, e.g., a magnetic recording medium such as a flexible disk or a cassette tape, an optical disc such as CD-ROM or DVD-ROM, a USB memory, or a memory card.

(Actions/Effects)

In accordance with the present embodiment as has been discussed above, first, the provisional classification execution unit 15a provisionally classifies and registers each record in a unit column which is the storage destination in accordance with the appearance rates of the keywords of classification names in the classification dictionary database 22, and then the product name registration unit 15b changes the provisionally registered product name to a standardized keyword and registers the standardized keyword in accordance with the appearance rates of the keywords of product names in the product name dictionary database 23. It is therefore possible to classify records which are registered at each shop in different classifications or with different product names, into a simply standardized unit column, and unify the product information by changing product names into appropriate product names.

Particularly, in accordance with the present embodiment, the dictionary search execution unit 15c defines the order of handling the dictionaries and keywords, and combination of keywords and the order of handling keywords when calculating the appearance rates of the keywords in the provisional classification execution unit 15a and the product name registration unit 15b. Specifically, for example, in the case where a product name “AAABB” is registered while the dictionary contains keywords of “AAABB” and “BB” and where the product name dictionary contains “AAA” having a longer string length and “BB” having a shorter string length, the dictionary search execution unit can search first for “AAA” having a longer string length on the basis of the string length so as to prevent the product name “AAABB” from being registered in the classification corresponding to “BB”. Also, for example, priority levels are assigned to the keywords of each product column to search for keywords in the descending order of the priority level.

Furthermore, in the case of the present embodiment, the dictionary search execution unit 15c makes use of combination of two or more keywords required for identifying the product name, for example, a product name and the form of the product. More specifically, keywords related to each other, for example, AA1, AA2 and AA3 can be constructed as all the possible combinations of these keywords such as AA1×AA2, AA1×AA3, AA2×AA1, AA2×AA3, AA3×AA1 and AA3×AA2 to perform AND search, OR search and so forth. In this case, more appropriate classification can be performed by searching for keywords in the descending order of the total string lengths of the keywords. Furthermore, the dictionary search execution unit 15c may have a function of generating a new search keyword by concatenating keywords which are related to each other, such as AA1AA2 and AA1AA3. The order of handling keywords which are decomposed and limited can be adjusted to improve the accuracy of analysis by combining this search keyword and original keywords, arbitrarily adjusting the string length and performing AND search, OR search and so forth.

Also, in the case of the present embodiment, since information other than product names is registered in the unit column, to which the product belongs, by referring to the annotation dictionary, additional information other than the classification and product name of the product can be registered in association with each other.

Furthermore, in accordance with the present embodiment, while search is performed in the provisional classification mode and the check mode, a check function is provided to notify the result when the results in the both modes are different from each other, and therefore, for example, in the case where there is a product name which is shared by different classifications, the result is notified to make it possible to determine which classification is more apt for the product name. Still further, since there is a learning function to reflect operation performed responsive to the notification in the respective dictionaries, it is possible to automatically classify the product in the subsequent registration process.

In the case of the present embodiment, since the dictionary search execution unit 15c decomposes the product names and the related information character strings in each record into words with which each dictionary is referred to, even when a product name and product related information are collectively input to a record at a storefront, provisional classification registration and product name registration can be performed with words which are minimum units, and therefore each record can be registered in an appropriate unit column.

### MODIFICATION EXAMPLES

Incidentally, the above explanation of the embodiment shows one example of the present invention. The present invention is therefore not limited to the embodiment of the present invention as described above, and various modifications and variations are possible in accordance with the design and so forth without departing from the spirit of the invention.

For example, while product information which is input is registered in a unit column on the basis of the product name dictionary database 23 after provisional classification registration with reference to the classification dictionary database 22 in the case of the present embodiment as has been discussed above, for example, the product information which is input can be registered directly in the unit column with reference to the product name dictionary database 23 without provisional classification registration.

In this case, the product name which is input is compared with the keywords of all the classifications by the same process as in the above check mode in which dictionary search is performed with all the classifications. Incidentally, even in this case, the order of handling keywords can be arbitrarily selected from among the priority, the string length, the combination of keywords and so forth.

Even in the case of such a modification, the product names are associated with the classifications 1 through 4 so that the product names can automatically be collected and classified into the product master information for each of the classifications 1 through 4. Additionally, since provisional registration can be omitted in this case, it is possible to improve the collection processing speed.

### EXPLANATION OF SYMBOLS

1 . . . management server
2 . . . database group
3 . . . information processing terminal
11 . . . communication interface
12 . . . input interface
13 . . . output interface
13a . . . display unit
14 . . . control unit
15 . . . product information registration unit
15a . . . provisional classification execution unit
15b . . . product name registration unit
15c . . . dictionary search execution unit
15d . . . check function unit
15e . . . learning function unit
15f . . . annotation registration unit
15g . . . keyword control unit
16 . . . product information search unit
17 . . . dictionary data generation unit
18 . . . memory
21 . . . product master information database
22 . . . classification dictionary database
23 . . . product name dictionary database
24 . . . annotation dictionary database
25 . . . JAN code database

1-12. (canceled)

13. A product code analysis system which analyzes an analysis target database capable of storing product names classified in a hierarchical structure as records, and collects product names on the basis of the hierarchical structure, said product code analysis system comprising:
an input interface through which records are input to the analysis target database while maintaining the hierarchical structure;
a classification dictionary structured to store keywords of classification names in each level of the hierarchical structure together with a unit column which is the storage destination of each product name in association with each other;
a product name dictionary structured to store, for each unit column classified in the hierarchical structure, keywords of product names belonging to the each unit column;
a provisional classification execution unit structured to provisionally classify and register each record of the analysis target database input through the input interface in accordance with the appearance rates of the keywords of classification names in the classification dictionary;
a product name registration unit structured to register, with respect to each record of the analysis target database, the product names of the each record in accordance with the appearance rates of the keywords of the product names of the product name dictionary on the basis of provisional classification and registration in the provisional classification execution unit; and
a dictionary search execution unit structured to define the order of handling the dictionaries and keywords, and combination of keywords and the order of handling keywords when calculating the appearance rates of the keywords in the provisional classification execution unit and the product name registration unit.

14. The product code analysis system of claim 13, further comprising:
an annotation dictionary structured to store, for each unit column classified in the hierarchical structure, information relating to product names registered in the product name dictionary; and
an annotation registration unit structured to register, with respect to each record of the analysis target database, information relating to the product name of each record in the unit column, to which the product belongs, in accordance with the appearance rates of keywords in the annotation dictionary,
wherein the dictionary search execution unit is structured to define the order of handling the dictionaries and keywords, and combination of keywords and the order of handling keywords when calculating the appearance rates of the keywords in the annotation registration unit.

15. The product code analysis system of claim 13, wherein the product name registration unit is structured to perform dictionary search for the product names in a provisional classification mode on the basis of the provisional classification and registration by the provisional classification execution unit, and dictionary search throughout all the classifications in a check mode irrespective of the result of the provisional classification and registration, and has a check function of notifying the search results when the results in the both modes are different from each other.

16. The product code analysis system of claim 15, further comprising:
a learning function unit structured to reflect the dictionary search results, which are obtained in the both modes, in the corresponding dictionaries on the basis of the result of the check function.

17. The product code analysis system of claim 13, wherein the dictionary search execution unit is structured to decompose the product names and the related information character strings in each record into words, and each dictionary is referred to for each word after the decomposition.

18. The product code analysis system of claim 13, wherein the dictionary search execution unit is provided further with a keyword control unit structured to set the order of handling keywords on the basis of the string length of each keyword and the string length of the keyword consisting of combination of keywords.

19. A product code analysis program which analyzes an analysis target database capable of storing product names classified in a hierarchical structure as records, and collects product names on the basis of the hierarchical structure, said product code analysis program causing a computer to perform the process comprising:
an input step of inputting records to the analysis target database through an input interface while maintaining the hierarchical structure;
a provisional classification execution step of reading a classification dictionary structured to store keywords of classification names in each level of the hierarchical structure together with a unit column which is the storage destination of each product name in association with each other, and provisionally classifying and registering each record of the analysis target database input through the input interface in accordance with the appearance rates of the keywords of classification names in the classification dictionary;
a product name registration step of reading a product name dictionary structured to store, for each unit column classified in the hierarchical structure, keywords of product names belonging to the each unit column, and registering, with respect to each record of the analysis target database, the product names of the each record in accordance with the appearance rates of the keywords of the product names of the product name dictionary on the basis of provisional classification and registration in the provisional classification execution step; and
a dictionary search execution step of defining the order of handling the dictionaries and keywords, and combination of keywords and the order of handling keywords when calculating the appearance rates of the keywords in the provisional classification execution step and the product name registration step.

20. The product code analysis program of claim 19 further comprising:
an annotation registration step of reading an annotation dictionary structured to store, for each unit column classified in the hierarchical structure, information relating to product names registered in the product name dictionary, and registering, with respect to each record of the analysis target database, information relating to the product name of each record in the unit column, to which the product belongs, in accordance with the appearance rates of keywords in the annotation dictionary,
wherein the dictionary search execution step is performed to define the order of handling the dictionaries and keywords, and combination of keywords and the order of handling keywords when calculating the appearance rates of the keywords in the annotation dictionary.

21. The product code analysis program of claim 19, wherein the product name registration step includes a check step of performing dictionary search for the product names in a provisional classification mode on the basis of the provisional classification and registration in the provisional classification execution step, and dictionary search throughout all the classifications in a check mode irrespective of the result of the provisional classification and registration, and notifying the search results when the results in the both modes are different from each other.

22. The product code analysis program of claim 21, further comprising:
a learning function step of reflecting the dictionary search results, which are obtained in the both modes, in the corresponding dictionaries on the basis of the result of the check step.

23. The product code analysis program of claim 19, wherein the dictionary search execution step is performed to decompose the product names and the related information character strings in each record into words, and each dictionary is referred to for each word after the decomposition.

24. The product code analysis program of claim 19, wherein the dictionary search execution step includes a keyword control step of setting the order of handling keywords on the basis of the string length of each keyword and the string length of the keyword comprising of combination of keywords.
